(19) United States
(12) Patent Application Publication
(10) Pub. No.: US 2026/0049964 A1
(43) Pub. Date: Feb. 19, 2026

(54) PRESSURE EQUALIZED QUARTZ CRYSTAL MICROBALANCE ASSEMBLY

(71) Applicant: ChampionX LLC, Sugar Land, TX (US)

(72) Inventors: Saugata Gon, Rosenberg, TX (US); Aldrin Josef Alegre, Katy, TX (US); Chris Arthur Galliano, II, Bryan, TX (US); Bella Kwan Ly, Richardson, TX (US); Jaden Alejandro Montalvo, San Antonio, TX (US); Martin Thomas Orpilla, Fulshear, TX (US); Christian Hoang Ta, Frisco, TX (US)

(21) Appl. No.: 19/301,202

(22) Filed: Aug. 15, 2025

Related U.S. Application Data
(60) Provisional application No. 63/684,221, filed on Aug. 16, 2024.

(51) Int. Cl. G01N 29/02; G01N 29/036; G01N 29/22

(52) U.S. Cl. CPC G01N 29/022; G01N 29/036; G01N 29/222; G01N 2291/0426

(57) ABSTRACT

A pressure-equalization holder is provided with a laboratory-scale reactor for measuring material deposition with a quartz crystal microbalance assembly. The pressure-equalization holder allows a process liquid from an interior of the laboratory-scale reactor to contact a liquid-facing crystal surface of a crystal of a quartz crystal microbalance assembly. The pressure-equalization holder also allows an inert fluid to contact an inert fluid-facing crystal surface of the crystal, where the inert fluid is at the same pressure as the process liquid.

### CROSS REFERENCE TO RELATED APPLICATIONS

This application is a non-provisional patent application claiming the benefit of, and priority to, U.S. Provisional Patent Application No. 63/684,221, filed Aug. 16, 2024, which is incorporated by reference herein in its entirety.

### FIELD OF THE DISCLOSURE

The present disclosure generally relates to quartz crystal microbalance assemblies for measuring material deposition.

### BACKGROUND

Quartz crystal microbalance technology provides a very sensitive way to measure material deposition on a surface of the crystal of a quartz crystal microbalance assembly. Quartz crystals exhibit a piezoelectric effect when alternating current or voltage is applied to the crystal via one or more electrodes. Quartz crystal microbalance assemblies (QCM assemblies) can be configured to operate in various modes, such as a thickness-shear mode or a flexural mode. The crystal oscillations generate a resonant frequency (e.g., a standing shear wave for thickness shear mode) for the crystal. A mass measurement determined from the resonant frequency depends upon the resonant frequency generated by oscillation of the quartz crystal. Thus, when a material is deposited upon the surface of the crystal, the resonant frequency correspondingly changes. The mass of material deposition is related to the difference in vibrating frequency of the crystal observed during the deposition period. Various techniques exist for calculation of the amount of material deposition (e.g., via mass value) based on the resonant frequencies of the crystal measured over time.

In addition to measuring the resonant frequency, QCM assemblies can be configured to measure dissipation (called quartz crystal microbalance with dissipation monitoring assemblies, or QCM-D assemblies) to characterize, on a nanoscale, the viscoelastic properties and thickness of the material that deposits on the surface of the quartz crystal of a QCM-D assembly.

Asphaltenes are highly prevalent in crude oils, thus requiring special attention during the extraction and processing of these crude oils. Asphaltenes can deposit on surfaces, e.g., blocking reservoir pores in near-well formations, depositing a layer of particles on production equipment (e.g., tubing, pumps), and depositing a layer of particles on equipment downstream of the production equipment (e.g., desalters, pipelines, etc.). Chemical treatment of crude oil with additives, such as dispersants and inhibitors, is one of the most commonly adopted control options for the remediation and prevention of asphaltene deposition.

In order to determine the effectiveness of an inhibitor for inhibiting asphaltene deposition during crude oil production in the field, laboratory tests may be performed. For example, a laboratory reactor having a QCM assembly may be used to measure the asphaltene deposition that is incurred after treatment with a variety of doses of the inhibitor in a laboratory setup. Based upon this laboratory testing, a prediction may be made for a suitable dose of inhibitor that will be expected to inhibit asphaltene deposition in the field.

A QCM assembly can be attached to a reactor where a hydrocarbon liquid can be agitated or flown and deposition of asphaltenes onto the quartz crystal can be measured over time, to evaluate the effectiveness of an asphaltene inhibitor and characterize viscoelastic properties of the asphaltene layer that deposit on the front side (facing the process liquid) of the quartz crystal. In configurations, the front side of the quartz crystal is exposed to the process liquid, while the back side of the quartz crystal is not. When a process liquid has temperatures and pressures greater than atmospheric values, the front side of the quartz crystal is exposed to the elevated temperatures and pressures of the process liquid, while the back side is exposed to atmospheric pressure and temperature. There is thus a pressure and temperature gradient across the thickness of the quartz crystal that can cause the quartz crystal to fracture and fail.

There is a need to measure asphaltene deposition with a QCM assembly inside a reactor setup under conditions that are greater than atmospheric pressure and temperature and higher shear/agitation without failure of the quartz crystal of the QCM assembly.

### SUMMARY

Described herein is a material deposition measurement system that includes: a laboratory-scale reactor having a first process hole formed in a side wall thereof; a pressure-equalization holder including: a first portion having a second process hole and a sensor cavity formed therein; a first seal having a third process hole formed therein and placed in the sensor cavity; a quartz crystal microbalance assembly (QCM assembly) placed in the sensor cavity to contact the first seal, wherein the first seal provides a first seal against a process side of a sensor holder of the QCM assembly; a second portion having a seal cavity formed therein and an inert fluid chamber formed therein, wherein the inert fluid chamber is fluidly connected to the seal cavity; and a second seal having an inert fluid hole formed therein and placed in the seal cavity, wherein the second seal provides a second seal against an inert side of the sensor holder of the QCM assembly, wherein the first process hole, the second process hole, and the third process hole fluidly connect a liquid-facing crystal surface of a crystal of the QCM assembly with an interior of the laboratory-scale reactor.

Also described herein is the pressure-equalization holder for a laboratory-scale material deposition system, wherein the pressure-equalization holder includes: a first portion having a first process hole and a sensor cavity formed therein; a first seal having a second process hole formed therein and placed in the sensor cavity; a quartz crystal microbalance assembly (QCM assembly) placed in the sensor cavity to contact the first seal, wherein the first seal provides a first seal against a process side of a sensor holder of the QCM assembly; a second portion having a seal cavity formed therein and an inert fluid chamber formed therein, wherein the inert fluid chamber is fluidly connected to the seal cavity; and a second seal having an inert fluid hole formed therein and placed in the seal cavity, wherein the second seal provides a second seal against an inert side of the sensor holder of the QCM assembly.

Also described herein is a process for operating a laboratory-scale reactor coupled to a pressure-equalization holder for a quartz crystal microbalance assembly (QCM assembly), the process including: flowing a liquid in or through the laboratory-scale reactor at a process pressure; during flowing, contacting the liquid with a liquid-facing crystal surface of a crystal of the QCM assembly that is contained in the pressure-equalization holder; during flowing, contacting an inert fluid with an inert fluid-facing crystal surface of the crystal of the QCM assembly that is contained in the pressure-equalization holder, wherein the inert fluid is at the process pressure; and detecting a resonant frequency of the crystal of the QCM assembly based on contacting the liquid.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 is a perspective view of laboratory-scale material deposition measurement system.

FIG. 2 is an exploded perspective view of the holder for a quartz crystal microbalance assembly (QCM assembly).

FIG. 3 is an exploded perspective view of the QCM assembly and seals from FIG. 2.

### DETAILED DESCRIPTION

The term “crystal” as used herein refers to a wafer of quartz crystal with electrodes connected to the wafer. The crystal can also be referred to as a resonator crystal, a piezoelectric resonator, or a quartz crystal microbalance sensor. The crystal can have a largest dimension (e.g., a diameter, a length, or a width) in a range of from 12.7 mm to 25.4 mm and a smallest dimension (e.g., a thickness) in a range of from 0.01 mm to 1 mm.

The term “inert fluid” as used herein refers to a liquid that is considered inert or neutral to the material deposition experiment that is conducted with a process liquid in the laboratory-scale reactor. For example, in the context of asphaltene deposition experimentation, the inert fluid can be an incompressible fluid such as water, ethylene glycol, propylene glycol, tetra ethylene glycol, cyclohexane or a combination thereof. In aspects, the inert fluid can have a density that is greater than the process liquid. In additional aspects, the inert fluid can be immiscible with the process liquid. The inert fluid is not the process liquid.

The term “process liquid” as used herein refers to the liquid that is tested during experiments disclosed herein, from which material can deposit onto the quartz crystal for material deposition measurements. In context of asphaltene deposition experimentation, the process liquid is liquid hydrocarbon, for example, a crude oil containing asphaltenes dissolved therein, dispersed therein, suspended therein, or a combination thereof.

The terms “quartz crystal microbalance assembly” and “QCM assembly, as well as uses in the plural form, include QCM devices that do not measure dissipation and that do measure dissipation. Those QCM devices that measure dissipation can additionally be referred to as quartz crystal microbalance with dissipation assembly (QCM-D assembly), as well as uses in the plural form.

Disclosed herein are a laboratory-scale reactor that measures material deposition of a process liquid with a quartz crystal microbalance assembly (QCM assembly), a pressure-equalization holder for the QCM assembly, and a process for measuring material deposition on a laboratory scale with a QCM assembly. The laboratory-scale reactor, pressure-equalization holder, and process are configured and operated such that both sides of the quartz crystal of the QCM assembly are exposed to the process pressure (e.g., pressure inside the laboratory-scale reactor) by contacting the side of the quartz crystal—that is usually the dry side—with an inert fluid, and exposing the inert fluid to the conditions of the process liquid in the interior of the laboratory-scale reactor.

In aspects, the inert fluid is exposed to the conditions of the process liquid by using a pressure-equalization line that connects the inert fluid in the pressure-equalization holder with the interior of the laboratory-scale reactor. The level of process liquid can be below the location where the pressure-equalization line connects to the wall of the laboratory-scale reactor, to prevent process liquid from mixing into the inert fluid. Additionally or alternatively, the inert fluid can have a density that is greater than the density of the process liquid, can be immiscible with the process liquid, or both, to prevent mixing of the process liquid with the inert fluid in the pressure-equalization holder disclosed herein, in the event that the process liquid comes into contact with the inert fluid. Exposure of the inert fluid with the conditions of the process liquid in the laboratory-scale reactor makes the pressure of the inert fluid the same as the pressure of the process liquid inside the reactor. Both sides of the quartz crystal of the QCM assembly are thus equal in pressure at any operating pressure for the reactor. For example, when testing is performed in the laboratory-scale reactor at a high pressure (equal to or less than 10,000 psig (68.9 MPag)), for example, 500 psig (3.45 MPag), the pressure on both sides of the quartz crystal of the QCM assembly is 500 psig (3.45 MPag), and pressure-equalization on both side of the QCM assembly minimizes the pressure differential across the thickness of the quartz crystal of the QCM assembly, which prevents fracture and failure of the quartz crystal.

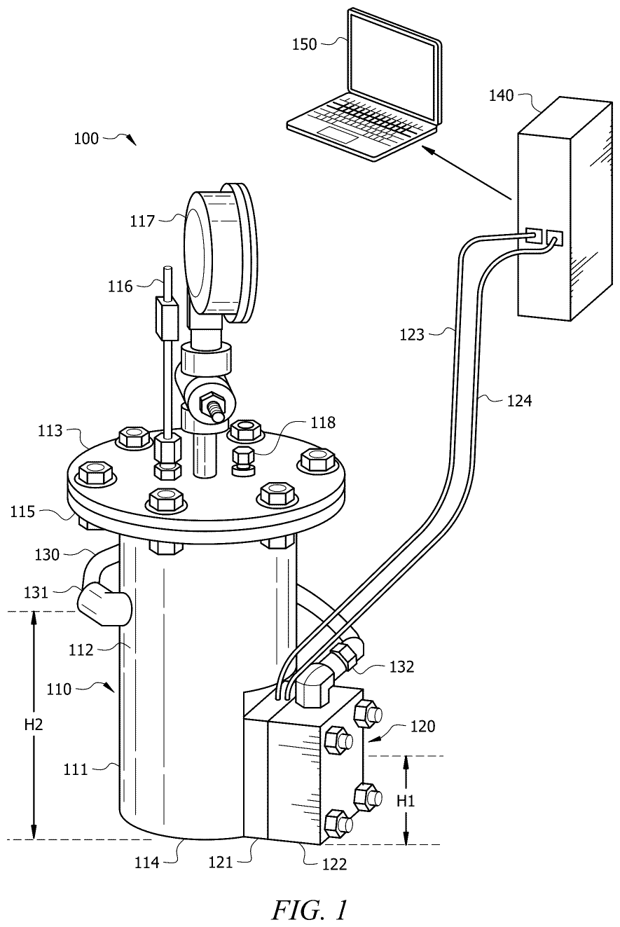

FIG. 1 is a perspective view of laboratory-scale material deposition measurement system 100. The system 100 includes a laboratory-scale reactor 110, a pressure-equalization holder 120 containing a QCM assembly and being connected to a wall 111 of a laboratory-scale reactor 110, a pressure-equalization line 130 fluidly connected to the wall 111 of the laboratory-scale reactor 110 and to the pressure-equalization holder 120, an oscillator/frequency analyzer 140, and a computer 150.

The laboratory-scale reactor 110 in FIG. 1 is illustrated as a batch reactor; however, it is contemplated that the laboratory-scale reactor 110 can be configured with stirring to be a continuous stirred tank reactor, as a plug flow reactor (a slot flow channel or a pipe) or a combination thereof.

In FIG. 1, the laboratory-scale reactor 110 has a body 112 and a lid 113.

The body 112 of the laboratory-scale reactor 110 shown in FIG. 1 has a cylindrical shape; however, it is contemplated that the body 112 can have any shape. The body 112 has wall 111 and a bottom 114 that define a hollow interior that can hold a process liquid for conducting experiments or testing for material deposition on the QCM assembly in the pressure-equalization holder 120. The top 115 of the body 112 is open so that process liquid can be placed in and removed from the body 112. Two holes are formed in the wall 111 of the body 112 of the laboratory-scale reactor 110. The first hole is formed in the wall 111 where the pressure-equalization holder 120 attaches to the laboratory-scale reactor 110, and the second hole is formed in the wall 111 where the pressure-equalization line 130 attaches to the laboratory-scale reactor 110.

Both holes are fluidly connected to the interior of the laboratory-scale reactor 110. The first hole enables the process liquid in the laboratory-scale reactor 110 to be exposed to the liquid-facing crystal surface 244 of the crystal 242 in the pressure-equalization holder 120, and the second hole enables the inert gas blanket that is over the process liquid in the laboratory-scale reactor 110 to be exposed to the inert fluid contained in the pressure-equalization holder 120, where the inert fluid is also exposed to the inert fluid-facing crystal surface 246 of the crystal 242.

The first hole is formed in the wall 111 at a height H1, where height H1 is defined as the distance from the bottom 114 of the body 112 to the first hole. The second hole is formed in the wall 111 at a height H2, where height H2 is defined as the distance from the bottom 114 of the body 112 to the second hole. In aspects disclosed herein, height H1 is less than height H2. Having H2 greater than H1 is beneficial to avoid mixing of process liquid with the inert fluid in pressure-equalization holder 120.

In operation of the laboratory-scale reactor 110, the level of the process liquid in the laboratory-scale reactor 110 can be lower than the height H2 so that no process liquid can enter the pressure-equalization line 130. The pressure of the system can be applied against i) the process liquid that is contained in the laboratory-scale reactor 110 and ii) the inert fluid that is contained in the pressure-equalization holder 120, via the inert gas blanket (e.g., nitrogen or air) that is above the process liquid in the laboratory-scale reactor 110 during experimentation/testing. This will ensure equal pressure is applied to the liquid-facing crystal surface 244 and the inert fluid-facing crystal surface 246 of the crystal 242, while minimize mixing of process liquid and inert fluid.

The lid 113 of the laboratory-scale reactor 110 covers the opening of the body 112, and can have any shape, size, or configuration. In FIG. 1, the lid 113 generally has a disc shape. The lid 113 can attach to the body 112 by any attachment means, such as the nut-and-bolt attachment illustrated in FIG. 1.

While not required for pressure-equalization, the laboratory-scale reactor 110 can include a temperature sensor 116, a pressure sensor 117, and an injection port 118 for purposes of conducting experiments for asphaltene deposition measurement. Other equipment or ports may be utilized for different types of material deposition measure, which would be known to those skilled in the art.

The temperature sensor 116 can be any laboratory thermocouple known in the art with the aid of this disclosure that is suitable for extending into the interior of the body 112 of the laboratory-scale reactor 110 and indicating and/or measuring temperatures in a range of from 0° C. to 160° C. during material deposition experiments. In some aspects, the temperature sensor 116 can include a digital display from which the temperature can be read by laboratory personnel, or a wire that connects to equipment for sending a temperature value to the computer 150.

The pressure sensor 117 can be any pressure gauge or pressure transducer known in the art with the aid of this disclosure that is suitable for extending into the interior of the body 112 of the laboratory-scale reactor 110 and indicating and/or measuring pressures in a range of from 0 psig (0 MPag) to 10,000 psig (68.9 MPag) during material deposition experiments.

The injection port 118 can be any port (e.g., conduit, valve connection) for introducing fluids of experiment (e.g., nitrogen for nitrogen blanket, heptane for asphaltene deposition experiments, or both) from outside the lid 113 of the laboratory-scale reactor 110 to the interior of the laboratory-scale reactor 110.

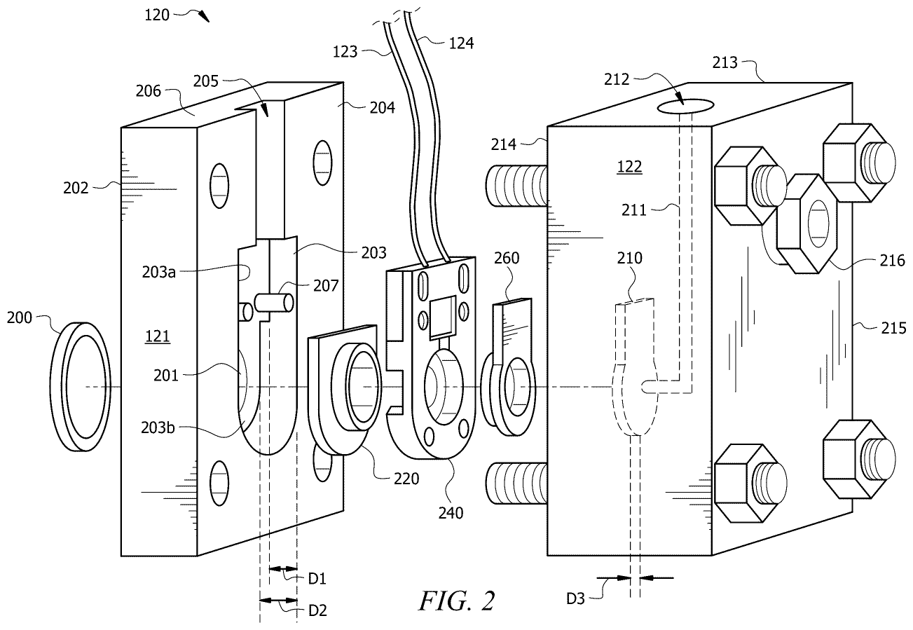

The pressure-equalization holder 120 is connected to a wall 111 of a laboratory-scale reactor 110. The pressure-equalization holder 120 includes a first portion 121 connected to a second portion 122. The first portion 121 can attach to the second portion 122 by any attachment means, such as the nut-and-bolt attachment illustrated in FIG. 1. The first portion 121 of the pressure-equalization holder 120 connects to the wall 111 of the laboratory-scale reactor 110. Inside the holder, which can be seen in FIG. 2, is a first seal, a QCM assembly, and a second seal.

The pressure-equalization line 130 can be any tube, conduit, or pipe having an end 131 to the second hole in the wall 111 of the laboratory-scale reactor 110 and an opposite end 132 connected to the second portion 122 of the pressure-equalization holder 120. In aspects, the pressure-equalization line 130 is filled with an inert gas (e.g., nitrogen), the inert fluid, the process liquid, or a combination thereof.

The system 100 can additionally include an oscillator/frequency analyzer 140 in electrical signal communication with the QCM assembly in the pressure-equalization holder 120. Wires 123 and 124 of the QCM assembly can be seen extending from the pressure-equalization holder 120 and connecting to the oscillator/frequency analyzer 140. Examples of the oscillator/frequency analyzer 140 include the Agilent Universal Frequency Counter or Universal Frequency Counter/Timer, the QSENSE Analyzer that is commercially available from Biolin Scientific AB, or any other commercially available analyzer for QCM.

The computer 150 is in wired or wireless signal communication with the oscillator/frequency analyzer 140. The computer 150 can be any computer that has at least one processor, memory, and instructions stored on the memory that cause the processor to receive the signal communications from the oscillator/frequency analyzer 140 and record/store/analyze the data for material deposition experiments. For example, the oscillator/frequency analyzer 140 and computer 150 are configured and adapted to receive an electrical signal from the QCM assembly via wires 123 and 124 that is representative of the oscillation frequency of the quartz crystal and to calculate a mass or mass flow rate of the asphaltene particles deposited on the liquid-facing crystal surface of the quartz crystal of the QCM assembly.

In operation of the system 100, with the end 131 of the pressure-equalization line 130 disconnected from the laboratory-scale reactor 110 and the lid 113 removed from the body 112 of the laboratory-scale reactor 110, the inert fluid can be placed in the pressure-equalization holder 120, for example, the inert fluid can be filled up to the view gauge 216. In some aspects, the inert fluid can be filled past the view gauge 216 and into the pressure-equalization line 130. The pressure-equalization line 130 can then be connected to the hole in the wall 111 of the laboratory-scale reactor 110. The process liquid can then be placed in the interior of the laboratory-scale reactor 110, for example, to a liquid level that is below the height H2 where the pressure-equalization line 130 is connected to the wall 111 of the laboratory-scale reactor 110. The lid 113 can then be attached to the body 112 of the laboratory-scale reactor 110. An inert gas blanket (e.g., nitrogen) can then be added via the injection port 118. During experiments, frequency analyzer 140 and computer 150 are operating. The process liquid can contact a liquid-facing crystal surface of the crystal of the QCM assembly that is contained in the pressure-equalization holder 120. Contact of the liquid with a liquid-facing crystal surface can result in deposition of material (e.g., asphaltenes from a hydrocarbon liquid) on the liquid-facing crystal surface. The oscillator/frequency analyzer 140 detects the resonant frequency and/or dissipation signals of the crystal of the QCM assembly (which can be a QCM assembly if measuring dissipation signals), and the oscillator/frequency analyzer 140 and/or the computer 150 can convert the resonant frequency to a material deposition value (and the dissipation, if applicable to the embodiment of the QCM assembly) to a material thickness value according to analytical techniques known in the art with the aid of this disclosure. This data can be used to characterize the performance of asphaltene inhibitors in a process liquid during experiments using the system 100.

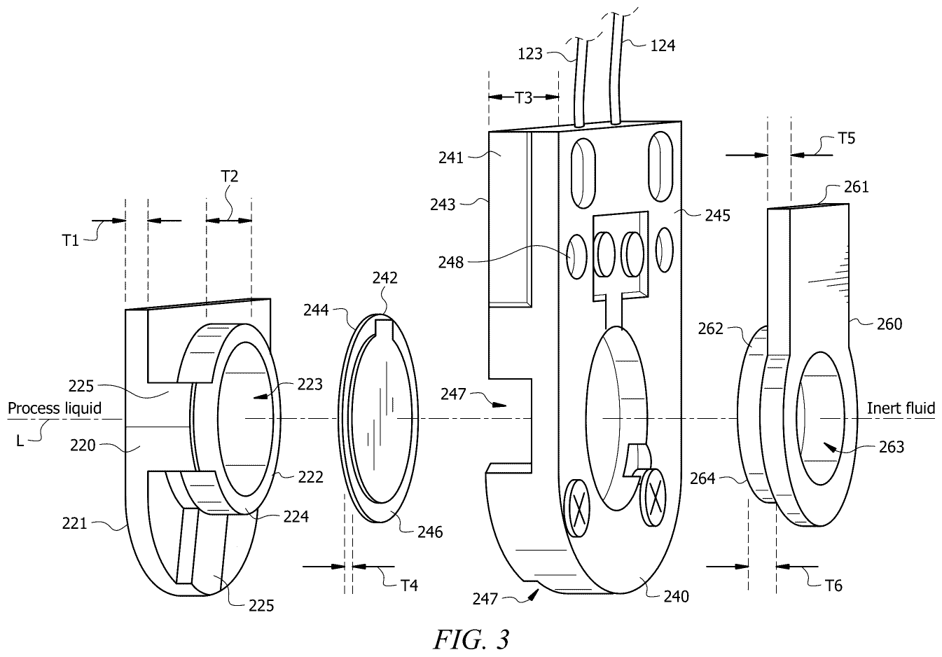

FIG. 2 is an exploded perspective view of the pressure-equalization holder 120 for a quartz crystal microbalance assembly (QCM assembly) 240, and FIG. 3 is an exploded perspective view of the QCM assembly 240 and seals 220 and 260 from FIG. 2. FIG. 2 and FIG. 3 are collectively used for the description below.

The pressure-equalization holder 120 has the first portion 121 and the second portion 122. Between the first portion 121 and second portion 122 of the pressure-equalization holder 120 are a first seal 220, a QCM assembly 240, and a second seal 260. In assembled configuration of the pressure-equalization holder 120, the first seal 220, the QCM assembly 240, and the second seal 260 are contained in the first portion 121 and second portion 122 of the pressure-equalization holder 120.

The reactor side 202 of the first portion 121 of the pressure-equalization holder 120 attaches to the laboratory-scale reactor 110. The reactor side 202 can be attached by any technique, such as adhesive, clamp, nut-and-bolt type of connection, or a combination thereof. To prevent leakage of process liquid at the interface between reactor side 202 of the first portion 121 and the wall 111 of the laboratory-scale reactor 110, an O-ring 200 can be included between the first portion 121 and the wall 111 of the laboratory-scale reactor 110. The O-ring 200 can be formed of any polymeric or elastomeric material that is suitable for use with the process liquid, e.g., suitable for use with hydrocarbons. Example of the material of the O-ring include thermoplastic polyurethane (TPU) and elastomers (e.g., a fluoroelastomer, a perfluoroelastomer).

In aspects, the first portion 121 is a rectangular block of metal having a process hole 201 machined into the reactor side 202 of the first portion 121. The rectangular block also has a sensor cavity 203 and a channel 205 machined into a holder side 204 of the first portion 121. The holder side 204 faces the second portion 122 of the pressure-equalization holder 120. The process hole 201 and sensor cavity 203 are fluidly connected in the disassembled view; however, when the pressure-equalization holder 120 is assembled, the process hole 201 and the process hole 223 in the first seal 220 form a continuous passage for process liquid to be exposed to the liquid-facing crystal surface 244 of the crystal 242, where no process liquid enters the sensor cavity 203.

The sensor cavity 203 can have a first portion 203a and a second portion 203b.

The first portion 203a has a depth D1 (as measured from the holder side 204 of the first portion 121) that is less than a depth D2 of the second portion 203b (as measured from the holder side 204 of the first portion 121). The depth D1 of the first portion 203a corresponds to the thickness T3 of the QCM assembly 240, and the depth D2 of the second portion 203b corresponds to a thickness T1 of the flat portion 221 of the first seal 220. Protrusions 207 can be formed on the first portion 203a of the sensor cavity 203, for extending into mating holes 248 that are formed in the sensor holder 241.

In aspects, the second portion 203b of the sensor cavity 203 is fluidly connected to the process hole 201. The sensor cavity 203 has a shape that corresponds to the QCM assembly 240. Thus, the sensor cavity 203 illustrated in FIG. 2 is not limited to the shape illustrated, since the shape corresponds to the QCM assembly 240 that is utilized for purposes of illustrating and describing this disclosure.

The channel 205 is of sufficient dimension for wires 123 and 124 of the QCM assembly 240 to extend through the channel 205 and out of the pressure-equalization holder 120 (e.g., the top 206 of the pressure-equalization holder 120). The channel 205 is fluidly connected to the sensor cavity 203, since the sensor cavity 203 receives the QCM assembly 240 and so that the wires 123 and 124 of the QCM assembly 240 can have a place to extend out of the pressure-equalization holder 120. When the pressure-equalization holder 120 is assembled, the process hole 201 and the process hole 223 in the first seal 220 form a continuous passage for process liquid to be exposed to the liquid-facing crystal surface 244 of the crystal 242, where no process liquid enters the sensor cavity 203 and no process liquid enters the channel 205. Further, when the pressure-equalization holder 120 is assembled, the inert fluid chamber 211 and the inert fluid hole 263 in the second seal 260 form a continuous passage for inert fluid to be exposed to the inert fluid-facing crystal surface 246 of the crystal 242, where no process liquid enters the seal cavity 210 and no inert fluid can move past the QCM assembly 240, ensuring that no inert fluid enters the sensor cavity 203 and no inert fluid enters the channel 205.

The first seal 220 has a process hole 223 formed therein that fluidly communicates with the process hole 201 of the first portion 121 of the pressure-equalization holder 120. The first seal 220 has a flat portion 221 and an annular portion 222 connected to the flat portion 221. In aspects, the flat portion 221 and the annular portion 222 are integrally formed of a single piece of material. The process hole 223 extends through both the flat portion 221 and the annular portion 222. The flat portion 221 faces the first portion 121 of the pressure-equalization holder 120, and the annular portion 222 faces the QCM assembly 240. The flat portion 221 has a thickness T1, and the annular portion 222 has a thickness T2. Thickness T1 of the flat portion 221 is equal to the difference between depths D1 and D2 of the sensor cavity 203. Thickness T2 of the annular portion 222 is sufficient to extend into the sensor holder 241 so that surface 224 of annular portion 222 contacts the liquid-facing crystal surface 244 of the crystal 242. The liquid-facing crystal surface 244 an also be referred to as the front or referred to as the first wet side of the crystal 242.

The flat portion 221 of the first seal 220 fits into the second portion 203b of the sensor cavity 203. The annular portion 222 of the first seal 220 fits into the sensor holder 241 so that surface 224 of annular portion 222 contacts the liquid-facing crystal surface 244 of the crystal 242.

The flat portion 221 also has protrusions 225 formed thereon, that protrude toward the sensor holder 241. The protrusions 225 are contoured and sized to fit into (mate with) notches 247 that are formed in the sensor holder 241.

In aspects, the first seal 220 can be formed of a metal or alloy, such as a stainless steel. The first seal 220 formed of metal or alloy can be machined from a block of the metal or alloy to the shape that fits between the sensor cavity 203 and the sensor holder 241 of the QCM assembly 240. Alternatively, the first seal 220 can be formed of a chemically compatible polymer such as thermoplastic polyurethane (TPU) or a chemically compatible elastomer such as a fluoroelastomer or a perfluoroelastomer. The first seal 220 formed of polymer or elastomer can be formed from a mold or 3D-printed, for example.

The quartz crystal microbalance assembly (QCM assembly) 240 has wires 123 and 124 extending therefrom. The QCM assembly 240 comprises a sensor holder 241 that holds the crystal 242. An example of the sensor holder 241 is the QSENSE ALD holder that is commercially available from Biolin Scientific AB. Examples of the crystal 242 include the QSENSE sensors that are commercially available from Biolin Scientific AB, or any other commercially available sensor that is compatible.

The sensor holder 241 has a thickness T3. An example value for thickness T3 is 5 mm. Exemplary width and length for the sensor holder 241 are 24 mm and 32 mm. The crystal 242 has a thickness T4, for example, in a range of from 0.01 mm to 1 mm. The crystal 242 is generally contained in, or held by, the sensor holder 241. In aspects, the crystal 242 can have a disc shape. The disc shape can be circular disc, rectangular disc, or any other shape. In aspects, the crystal 242 has a metal or alloy coating functioning as electrodes.

The QCM assembly 240 is placed in the first portion 203a of the sensor cavity 203, in contact the first seal 220. The wires 123 and 124 extend out of the first portion 121 of the pressure-equalization holder 120 via the channel 205. The first seal 220 provides a first seal against a process side 243 of the sensor holder 241 and or the liquid-facing crystal surface 244 of the crystal 242 of the QCM assembly 240.

The second portion 122 of the pressure-equalization holder 120 has a seal cavity 210 and an inert fluid chamber 211 formed therein. The inert fluid chamber 211 is fluidly connected to the seal cavity 210. The seal cavity 210 can be machined into the sensor side 214 of the second portion 122 at a depth D3. The shape of the seal cavity 210 corresponds to the shape of the second seal 260, and the depth D3 of the seal cavity 210 correspond to the thickness T5 of the flat portion 261 of the second seal 260. The inert fluid chamber 211 is machined into a top 213 of the second portion 122 so as to fluidly connect with the seal cavity 210 such that an inert fluid that is introduced into the inert fluid chamber 211 can flow into any space of the seal cavity 210 when the second seal 260 is placed in the seal cavity 210, e.g., so that inert fluid can flow into the inert fluid hole 263 formed in the second seal 260. The inert fluid chamber 211 has an end that defines an opening 212 on the top 213 of the second portion 122; however, the opening 212 can be located on any other side (e.g., side 215) of the second portion 122. Side 215 has a view gauge 216 installed thereon, that can allow sight of the level of the inert fluid in the inert fluid chamber 211. Nuts and bolts are shown in FIG. 2 as the means by which the pressure-equalization holder 120 is assembled and secured together.

The second seal 260 has an inert fluid hole 263 formed therein. The second seal 260 has a flat portion 261 connected to an annular portion 262. In aspects, the flat portion 261 and the annular portion 262 are integrally formed of a single piece of material. The flat portion 261 can be placed in the seal cavity 210 of the second portion 122. The second seal 260 provides a second seal against an inert side 245 of the sensor holder 241 of the QCM assembly 240. The inert fluid hole 263 extends through both the flat portion 261 and the annular portion 262. The flat portion 261 faces the second portion 122 of the pressure-equalization holder 120, and the annular portion 262 faces the QCM assembly 240. The flat portion 261 has a thickness T5, and the annular portion 262 has a thickness T6. Thickness T5 of the flat portion 261 is equal to the depth D3 of the seal cavity 210. Thickness T6 of the annular portion 262 is sufficient to extend into the sensor holder 241 so that surface 264 of annular portion 262 contacts the inert fluid-facing crystal surface 246 of the crystal 242. The inert fluid-facing crystal surface 246 can also be referred to as the back or referred to as the second wet side of the crystal 242.

The flat portion 261 of the second seal 260 fits into the seal cavity 210. The annular portion 262 of the second seal 260 fits into the sensor holder 241 so that surface 264 of annular portion 262 contacts the inert fluid-facing crystal surface 246 of the crystal 242.

In aspects, the second seal 260 can be formed of a metal or alloy, such as a stainless steel. The second seal 260 formed of metal or alloy can be machined from a block of the metal or alloy to the shape that fits between the seal cavity 210 and the sensor holder 241 of the QCM assembly 240. Alternatively, the second seal 260 can be formed of a chemically compatible polymer such as thermoplastic polyurethane (TPU) or a chemically compatible elastomer such as a fluoroelastomer or a perfluoroelastomer. The second seal 260 formed of polymer or elastomer can be formed from a mold or 3D-printed, for example.

In aspects, the process hole 201 and the process hole 223 fluidly connect the liquid-facing crystal surface 244 of a crystal 242 of the QCM assembly 240 with the interior of the laboratory-scale reactor 110.

In aspects, the inert fluid hole 263, the inert fluid chamber 211, and the pressure-equalization line 130 fluidly connect the inert fluid-facing crystal surface 246 of the crystal 242 of the QCM assembly 240 with the interior of the laboratory-scale reactor 110.

In aspects, the process hole 201, process hole 223, crystal 242, and inert fluid hole 263 share a common longitudinal axis L.

A process for operating a laboratory-scale reactor 110 coupled to a pressure-equalization holder 120 for a QCM assembly 240 is disclosed. The process can include flowing a liquid in or through the laboratory-scale reactor 110 at a process pressure; during flowing, contacting the liquid with a liquid-facing crystal surface 244 of a crystal 242 of the QCM assembly 240 that is contained in the pressure-equalization holder 120; during flowing, contacting an inert fluid with an inert fluid-facing crystal surface 246 of the crystal 242 of the QCM assembly 240 that is contained in the pressure-equalization holder 120, wherein the inert fluid is at the process pressure; and detecting a resonant frequency of the crystal 242 of the QCM assembly 240 based on contacting the liquid. The process can further include converting (for example with the frequency analyzer 140 and computer 150) the resonant frequency to a material deposition value (e.g., an asphaltene deposition value). In aspects, the process pressure is greater than atmospheric pressure and equal to or less than 10,000 psig (68.9 MPag), for example, 500 psig (3.45 MPag).

### Additional Description

Aspect 1. A material deposition measurement system comprising: a laboratory-scale reactor having a first process hole formed in a side wall thereof; and a pressure-equalization holder comprising: a first portion having a second process hole and a sensor cavity formed therein; a first seal having a third process hole formed therein and placed in the sensor cavity; a quartz crystal microbalance assembly (QCM assembly) placed in the sensor cavity to contact the first seal, wherein the first seal provides a first seal against a process side of a sensor holder of the QCM assembly; a second portion having a seal cavity formed therein and an inert fluid chamber formed therein, wherein the inert fluid chamber is fluidly connected to the seal cavity; and a second seal having an inert fluid hole formed therein and placed in the seal cavity, wherein the second seal provides a second seal against an inert side of the sensor holder of the QCM assembly, wherein the first process hole, the second process hole, and the third process hole fluidly connect a liquid-facing crystal surface of a crystal of the QCM assembly with an interior of the laboratory-scale reactor.

Aspect 2. The material deposition measurement system of Aspect 1, wherein the laboratory-scale reactor has a first process hole formed in a side wall therein, wherein the QCM assembly is contained in a pressure-equalization holder that is attached to the side wall of the laboratory-scale reactor and over the first process hole.

Aspect 3. The material deposition measurement system of Aspect 2, wherein the pressure-equalization holder comprises: a first portion having a second process hole and a sensor cavity formed therein; a first seal having a third process hole formed therein and placed in the sensor cavity, wherein the first seal provides a first seal against a process side of a sensor holder of the QCM assembly; a second portion having a seal cavity formed therein and an inert fluid chamber formed therein, wherein the inert fluid chamber is fluidly connected to the seal cavity; and a second seal having an inert fluid hole formed therein and placed in the seal cavity, wherein the second seal provides a second seal against an inert side of the sensor holder of the QCM assembly.

Aspect 4. The material deposition measurement system of Aspect 2 or 3, wherein the first process hole, the second process hole, and the third process hole fluidly connect the liquid-facing crystal surface of the crystal with an interior of the laboratory-scale reactor.

Aspect 5. The material deposition measurement system of Aspect 2, 3, or 4, wherein an inert fluid is contained in the inert fluid chamber and contacts a fluid-facing crystal surface of the crystal via the inert fluid hole.

Aspect 6. The material deposition measurement system of Aspect 2, further comprising: a pressure-equalization line having an end connected to a pressure-equalization hole formed in the side wall of the laboratory-scale reactor and an opposite end fluidly connected to the inert fluid chamber of the second portion of the pressure-equalization holder, wherein the inert fluid chamber is fluidly connected to an interior of the laboratory-scale reactor via the pressure-equalization line.

Aspect 7. The material deposition measurement system of Aspect 6, wherein the pressure-equalization line connects to the side wall of the laboratory-scale reactor at height on the laboratory-scale reactor that is greater than a height on the laboratory-scale reactor where the pressure-equalization holder is connected.

Aspect 8. The material deposition measurement system of Aspect 6 or 7, wherein the inert fluid hole, the inert fluid chamber, and the pressure-equalization line fluidly connect a fluid-facing crystal surface of the crystal of the QCM assembly with the interior of the laboratory-scale reactor.

Aspect 9. The material deposition measurement system of any one of Aspects 1 to 8, wherein the first seal comprises a flat portion and an annular portion connected to the flat portion, wherein the sensor cavity comprises a first portion and a second portion, wherein the sensor holder fits in the first portion of the sensor cavity, wherein the flat portion of the first seal fits in the second portion of the sensor cavity, and wherein the annular portion fits into the sensor holder.

Aspect 10. The material deposition measurement system of Aspect 9, wherein the second seal comprises a flat portion and an annular portion connected to the flat portion, wherein the flat portion fits into the seal cavity, wherein the annular portion fits into the sensor holder.

Aspect 11. A pressure-equalization holder for a laboratory-scale material deposition system, wherein the pressure-equalization holder comprises: a first portion having a first process hole and a sensor cavity formed therein; a first seal having a second process hole formed therein and placed in the sensor cavity; a quartz crystal microbalance assembly (QCM assembly) placed in the sensor cavity to contact the first seal, wherein the first seal provides a first seal against a process side of a sensor holder of the QCM assembly; a second portion having a seal cavity formed therein and an inert fluid chamber formed therein, wherein the inert fluid chamber is fluidly connected to the seal cavity; and a second seal having an inert fluid hole formed therein and placed in the seal cavity, wherein the second seal provides a second seal against an inert side of the sensor holder of the QCM assembly.

Aspect 12. The pressure-equalization holder of Aspect 11, wherein the first process hole, the second process hole, and the inert fluid hole share a common longitudinal axis.

Aspect 13. The pressure-equalization holder of Aspect 11 or 12, wherein the first seal comprises a flat portion and an annular portion connected to the flat portion, wherein the sensor cavity comprises a first portion and a second portion, wherein the sensor holder fits in the first portion of the sensor cavity, wherein the flat portion of the first seal fits in the second portion of the sensor cavity, and wherein the annular portion fits into the sensor holder.

Aspect 14. The pressure-equalization holder of any one of Aspects 11 to 13, wherein the second seal comprises a flat portion and an annular portion connected to the flat portion, wherein the flat portion fits into the seal cavity, wherein the annular portion fits into the sensor holder.

Aspect 15. A process for operating a laboratory-scale reactor coupled to a pressure-equalization holder for a quartz crystal microbalance assembly (QCM assembly), the process comprising: flowing a liquid in or through the laboratory-scale reactor at a process pressure; during flowing, contacting the liquid with a liquid-facing crystal surface of a crystal of the QCM assembly that is contained in the pressure-equalization holder; during flowing, contacting an inert fluid with an inert fluid-facing crystal surface of the crystal of the QCM assembly that is contained in the pressure-equalization holder, wherein the inert fluid is at the process pressure; and detecting a resonant frequency of the crystal of the QCM assembly based on contacting the liquid.

Aspect 16. The process of Aspect 15, further comprising: converting the resonant frequency to an asphaltene deposition value.

Aspect 17. The process of Aspect 15 or 16, wherein the laboratory-scale reactor has a first process hole formed in a side wall therein, wherein the QCM assembly is contained in a pressure-equalization holder that is attached to the side wall of the laboratory-scale reactor and over the first process hole.

Aspect 18. The process of Aspect 17, wherein the pressure-equalization holder comprises: a first portion having a second process hole and a sensor cavity formed therein; a first seal having a third process hole formed therein and placed in the sensor cavity, wherein the first seal provides a first seal against a process side of a sensor holder of the QCM assembly; a second portion having a seal cavity formed therein and an inert fluid chamber formed therein, wherein the inert fluid chamber is fluidly connected to the seal cavity; and a second seal having an inert fluid hole formed therein and placed in the seal cavity, wherein the second seal provides a second seal against an inert side of the sensor holder of the QCM assembly.

Aspect 19. The process of Aspect 18, wherein the first process hole, the second process hole, and the third process hole fluidly connect the liquid-facing crystal surface of the crystal with an interior of the laboratory-scale reactor.

Aspect 20. The process of Aspect 18 or 19, wherein the inert fluid is contained in the inert fluid chamber and contacts the inert fluid-facing crystal surface via the inert fluid hole.

Aspect 21. The process of Aspect 18, 19, or 20, wherein the inert fluid chamber is fluidly connected to an interior of the laboratory-scale reactor via a pressure-equalization line.

Aspect 22. The process of Aspect 21, wherein the pressure-equalization line connects to the side wall of the laboratory-scale reactor at height on the laboratory-scale reactor that is greater than a height on the laboratory-scale reactor where the pressure-equalization holder is connected.

Aspect 23. The process of any one of Aspects 15 to 22, wherein the process pressure is greater than atmospheric pressure and equal to less than 10,000 psig (68.9 MPag).

Although the present disclosure and its advantages have been described in detail, it should be understood that various changes, substitutions, and alterations can be made herein without departing from the spirit and scope of the disclosure as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A material deposition measurement system comprising:
a laboratory-scale reactor having a first process hole formed in a side wall thereof; and
a pressure-equalization holder comprising:
a first portion having a second process hole and a sensor cavity formed therein;
a first seal having a third process hole formed therein and placed in the sensor cavity;
a quartz crystal microbalance assembly (QCM assembly) placed in the sensor cavity to contact the first seal, wherein the first seal provides a first seal against a process side of a sensor holder of the QCM assembly;
a second portion having a seal cavity formed therein and an inert fluid chamber formed therein, wherein the inert fluid chamber is fluidly connected to the seal cavity; and
a second seal having an inert fluid hole formed therein and placed in the seal cavity, wherein the second seal provides a second seal against an inert side of the sensor holder of the QCM assembly,
wherein the first process hole, the second process hole, and the third process hole fluidly connect a liquid-facing crystal surface of a crystal of the QCM assembly with an interior of the laboratory-scale reactor.

2. The material deposition measurement system of claim 1, wherein the laboratory-scale reactor has a first process hole formed in a side wall therein, wherein the QCM assembly is contained in a pressure-equalization holder that is attached to the side wall of the laboratory-scale reactor and over the first process hole.

3. The material deposition measurement system of claim 2, wherein the pressure-equalization holder comprises:
a first portion having a second process hole and a sensor cavity formed therein;
a first seal having a third process hole formed therein and placed in the sensor cavity, wherein the first seal provides a first seal against a process side of a sensor holder of the QCM assembly;
a second portion having a seal cavity formed therein and an inert fluid chamber formed therein, wherein the inert fluid chamber is fluidly connected to the seal cavity; and
a second seal having an inert fluid hole formed therein and placed in the seal cavity, wherein the second seal provides a second seal against an inert side of the sensor holder of the QCM assembly.

4. The material deposition measurement system of claim 2, wherein the first process hole, the second process hole, and the third process hole fluidly connect the liquid-facing crystal surface of the crystal with an interior of the laboratory-scale reactor.

5. The material deposition measurement system of claim 2, wherein an inert fluid is contained in the inert fluid chamber and contacts a fluid-facing crystal surface of the crystal via the inert fluid hole.

6. The material deposition measurement system of claim 2, further comprising:
a pressure-equalization line having an end connected to a pressure-equalization hole formed in the side wall of the laboratory-scale reactor and an opposite end fluidly connected to the inert fluid chamber of the second portion of the pressure-equalization holder, wherein the inert fluid chamber is fluidly connected to an interior of the laboratory-scale reactor via the pressure-equalization line.

7. The material deposition measurement system of claim 6, wherein the pressure-equalization line connects to the side wall of the laboratory-scale reactor at height on the laboratory-scale reactor that is greater than a height on the laboratory-scale reactor where the pressure-equalization holder is connected.

8. The material deposition measurement system of claim 6, wherein the inert fluid hole, the inert fluid chamber, and the pressure-equalization line fluidly connect a fluid-facing crystal surface of the crystal of the QCM assembly with the interior of the laboratory-scale reactor.

9. The material deposition measurement system of claim 1, wherein the first seal comprises a flat portion and an annular portion connected to the flat portion, wherein the sensor cavity comprises a first portion and a second portion, wherein the sensor holder fits in the first portion of the sensor cavity, wherein the flat portion of the first seal fits in the second portion of the sensor cavity, and wherein the annular portion fits into the sensor holder.

10. The material deposition measurement system of claim 9, wherein the second seal comprises a flat portion and an annular portion connected to the flat portion, wherein the flat portion fits into the seal cavity, wherein the annular portion fits into the sensor holder.

11. A pressure-equalization holder for a laboratory-scale material deposition system, wherein the pressure-equalization holder comprises:
a first portion having a first process hole and a sensor cavity formed therein;
a first seal having a second process hole formed therein and placed in the sensor cavity;
a quartz crystal microbalance assembly (QCM assembly) placed in the sensor cavity to contact the first seal, wherein the first seal provides a first seal against a process side of a sensor holder of the QCM assembly;
a second portion having a seal cavity formed therein and an inert fluid chamber formed therein, wherein the inert fluid chamber is fluidly connected to the seal cavity; and
a second seal having an inert fluid hole formed therein and placed in the seal cavity, wherein the second seal provides a second seal against an inert side of the sensor holder of the QCM assembly.

12. The pressure-equalization holder of claim 11, wherein the first process hole, the second process hole, and the inert fluid hole share a common longitudinal axis.

13. The pressure-equalization holder of claim 11, wherein the first seal comprises a flat portion and an annular portion connected to the flat portion, wherein the sensor cavity comprises a first portion and a second portion, wherein the sensor holder fits in the first portion of the sensor cavity, wherein the flat portion of the first seal fits in the second portion of the sensor cavity, and wherein the annular portion fits into the sensor holder.

14. The pressure-equalization holder of claim 11, wherein the second seal comprises a flat portion and an annular portion connected to the flat portion, wherein the flat portion fits into the seal cavity, wherein the annular portion fits into the sensor holder.

15. A process for operating a laboratory-scale reactor coupled to a pressure-equalization holder for a quartz crystal microbalance assembly (QCM assembly), the process comprising:
flowing a liquid in or through the laboratory-scale reactor at a process pressure;
during flowing, contacting the liquid with a liquid-facing crystal surface of a crystal of the QCM assembly that is contained in the pressure-equalization holder;
during flowing, contacting an inert fluid with an inert fluid-facing crystal surface of the crystal of the QCM assembly that is contained in the pressure-equalization holder, wherein the inert fluid is at the process pressure; and
detecting a resonant frequency of the crystal of the QCM assembly based on contacting the liquid.

16. The process of claim 15, further comprising:
converting the resonant frequency to an asphaltene deposition value.

17. The process of claim 15, wherein the laboratory-scale reactor has a first process hole formed in a side wall therein, wherein the QCM assembly is contained in a pressure-equalization holder that is attached to the side wall of the laboratory-scale reactor and over the first process hole.

18. The process of claim 17, wherein the pressure-equalization holder comprises:
a first portion having a second process hole and a sensor cavity formed therein;
a first seal having a third process hole formed therein and placed in the sensor cavity, wherein the first seal provides a first seal against a process side of a sensor holder of the QCM assembly;
a second portion having a seal cavity formed therein and an inert fluid chamber formed therein, wherein the inert fluid chamber is fluidly connected to the seal cavity; and
a second seal having an inert fluid hole formed therein and placed in the seal cavity, wherein the second seal provides a second seal against an inert side of the sensor holder of the QCM assembly.

19. The process of claim 18, wherein:
i) the first process hole, the second process hole, and the third process hole fluidly connect the liquid-facing crystal surface of the crystal with an interior of the laboratory-scale reactor;
ii) the inert fluid is contained in the inert fluid chamber and contacts the inert fluid-facing crystal surface via the inert fluid hole; or
iii) the inert fluid chamber is fluidly connected to an interior of the laboratory-scale reactor via a pressure-equalization line, wherein the pressure-equalization line connects to the side wall of the laboratory-scale reactor at height on the laboratory-scale reactor that is greater than a height on the laboratory-scale reactor where the pressure-equalization holder is connected.

20. The process of claim 15, wherein the process pressure is greater than atmospheric pressure and equal to less than 10,000 psig (68.9 MPag).
